(19) United States
(12) Patent Application Publication
(10) Pub. No.: US 2022/0127378 A1
(43) Pub. Date: Apr. 28, 2022

(54) ACETYLATION OF NATURAL FIBRES TO OBTAIN THE FIBROUS STRUCTURE

(71) Applicant: CERDIA INTERNATIONAL GMBH, Basel (CH)

(72) Inventors: Armin STEIN, Kenzingen (DE); Jana LUBKOLL, Freiburg (DE)

(21) Appl. No.: 17/431,537

(22) PCT Filed: Feb. 11, 2020
(86) PCT No.: PCT/EP2020/053426

§ 371 Date: Aug. 17, 2021

(30) Foreign Application Priority Data
Feb. 18, 2019 (EP) 19157692.5

(51) Int. Cl. C08B 3/20; C08L 1/12

(52) U.S. Cl. CPC C08B 3/20; C08L 1/12

(57) ABSTRACT

The invention relates to a method for the acetylation of lignocellulose-containing fibrous materials and to acetylated lignocellulose-containing fibrous materials obtained according to said method, and to the use thereof.

The present invention relates to a method for the acetylation of lignocellulosic fibrous materials, an acetylated lignocellulosic fibrous material produced by said method, as well as the use of such a fibrous material as a component of composite materials, building materials and insulating materials as well as absorptive materials for oil.

Lignocellulosic fibrous materials, especially in the form of natural fibers, are of great interest as components of composite materials, components of construction materials as well as components of insulating materials. These fibrous materials are renewable resources stemming from agricultural and forestry production and their production is CO₂-neutral. In many sectors, these products can replace raw material products obtained from fossil carbon carriers like plastics, for example, and thus contribute to a reduction in the usage of raw fossil materials and to an improvement of the CO₂ balance.

While these lignocellulosic materials have many advantages in the cited realms, one disadvantage of the materials is their hydrophilicity, which results in the materials produced with such fibers retaining water and then being able to release it again when the ambient conditions change. This leads to a certain degree of swelling or respectively shrinkage of the materials, which is coupled with disadvantages such as cracking, deforming and the like. When the materials are used as insulating materials, there is an additional disadvantage of the water retention being able to severely impair the insulation properties.

A further disadvantage to the hydrophilic properties of lignocellulosic fibrous materials stems from the observance of insufficient compatibility with many surface treatments. The hydrophilic character of the fibrous materials thus hinders the bonding and painting capability of the materials.

The hydrophilic character of the fibrous materials also makes them microbiologically unstable. Upon a microbiological attack, the materials degrade and/or discolor and there is a corresponding loss in the materials' dimensional stability. Moreover, the attack can also have harmful consequences for humans, particularly in the case of mold, this being of particular consequence when they are used as building materials. Biocides and fungicides are therefore often used with such materials in order to counteract such microbial attacks although doing so is costly and out of keeping with the biological character of the materials.

In order to avoid this disadvantage, it is known in the prior art to render lignocellulosic fibrous materials hydrophobic by means of acetylation, whereby the fiber's thermal stability can also be improved. To date, there have essentially been two known methods.

In one method variant, the acetylation of the lignocellulosic fibrous materials ensues using acetylation materials such as acetic anhydride, ketene or isopropenyl acetate at high pressure and high temperatures over a long period of time. Sufficient acetylation of the fibrous materials is achieved under these reaction conditions. However, a disadvantage to this method variant is that severe side reactions cause a distinct discoloration of the lignocellulosic fibrous materials. Furthermore, the reaction conditions also lead to the formation of by-products such as for example furfuraldehyde, these producing an unpleasant odor and moreover not being toxicologically harmless.

In the second method variant, the acetylation ensues under milder conditions by means of acetylating agents, whereby catalysts are used. Yet this method variant has the disadvantage of it being very difficult to completely remove the catalyst from the acetylated fiber. Catalyst residues on the acetylated fiber do, however, lead to destabilization of the product.

The present invention has therefore been based on the task of providing a method for the acetylation of lignocellulosic fibers which overcomes the above-described disadvantages. The particular task of the present invention is that of providing a method for the acetylation of lignocellulosic fibers, particularly in the form of natural fibers, with which a stable acetylated fiber can be obtained without ensuing discoloration and/or the generating of odorous and/or toxicologically risky by-products and with which the acetylated fibers remain stable over a long period of time.

The task according to the invention is solved by a method for the acetylation of lignocellulosic fibrous materials which comprises the steps:
i) treating the lignocellulosic fibrous material with acetic anhydride in the absence of a catalyst under the conditions of a pressure no greater than 0.5 bar above standard pressure (101325 Pa) and a temperature of ≤200° C.,
ii) separating the acetylated lignocellulosic fibrous material from the excess acetic anhydride, and
iii) distillatively separating the acetic acid generated during acetylation.

The inventors have surprisingly discovered that the inventive method steps, and in particular the treatment of the lignocellulosic fibrous material with acetic anhydride under mild conditions in the absence of a catalyst, enables a beneficially acetylated product to be produced which is of negligible discoloration and which fully excludes the development of odorous or toxicologically risky by-products to the greatest possible extent during its production. At the same time, by not using a catalyst, no problems arise with respect to the fiber's long-term stability.

As stated above, the acetylation in the context of the present invention is characterized by conditions of not significantly increased pressure; i.e. in particular a pressure of no greater than 00.5 bar above standard pressure (101325 Pa), and a temperature of ≤200° C., preferably ≤180° C., and particularly preferentially ≤160° C. These temperature specifications can largely prevent the formation of by-products such as furfuraldehyde. On the other hand, the temperature should be high enough to ensure the fastest possible reaction of the lignocellulosic fibrous material. It is thus opportune for the temperature to be at least 90° C., preferentially at least 100° C., further preferentially at least 120° C., and particularly preferentially at least 130° C. Most preferentially, the reaction ensues at about 140° C. at standard pressure, which corresponds to the boiling point of the acetic anhydride. The acetylation in the context of the present invention is advantageously realized such that the fibrous structure is preserved under the reaction conditions so that the fibers are not for example dissolved during the reaction and then regenerated by adding a precipitant.

A catalyst in the context of the invention is a compound which participates in the reaction between lignocellulosic fibrous material and acetic anhydride by lowering the energy barrier for the reaction. Common catalysts for acetylation reactions, particularly of lignocellulose, are for example alkali metal acetates such as sodium or potassium acetate or nitrogenous heterocyclic compounds such as pyridine and 4-dimethylaminopyridine. The specification of “in the absence of a catalyst” is to be understood as not adding an effective amount of a compound having a catalytic effect on the acetylation reaction to the acetic anhydride used in the reaction and the lignocellulosic fibrous material. Although very small catalyst amounts, such as in particular less than 100 ppm, preferably less than 10 ppm, and further preferentially less than 5 ppm, can be tolerated, it is however most preferential for no catalyst to be included in the reaction.

Natural fibers are particularly suitable as lignocellulosic fibrous materials, for example hemp fibers, flax fibers, jute fibers, rapeseed fibers, miscanthus fibers and palm fibers. In the context of the present invention, wood fibers are less suitable as fibrous material due to their generally shorter fiber length such that in one preferential embodiment, the lignocellulosic fibrous material is neither wood nor a fibrous material derived therefrom.

The lignocellulosic fibrous materials can be dried prior to the acetylation reaction in i), e.g. to a residual moisture content of <1%. The drying process in this case can occur at an increased temperature such as 60° C. or higher, and in particular 80° C. or higher, yet below a temperature at which the fibrous material discolors due to pyrolysis. A temperature in the range of from 80° C. to 95° C. can be specified as being particularly suitable. To support the drying process, it can be performed at reduced pressure (i.e. less than 800 mbar, for example). A pressure in the range of about 50 to 100 mbar is noted as being particularly suitable. As a general rule, drying for a period of from 4 to 12 h affords sufficiently low enough residual moisture and is therefore preferential within the context of the invention.

However, drying the lignocellulosic fibrous material is not absolutely necessary since any residual moisture still present in the material can also be converted to acetic acid by conversion with excess acetic anhydride. In this case, the drying ensues in situ with the lignocellulosic fibrous material/acetic anhydride reaction. In this case, a slightly larger amount of acetic anhydride needs to be included in the reaction depending on the moisture content. When a non-dried, lignocellulosic fibrous material is used in the reaction, its residual moisture content generally lies in the range of approximately 6 to approximately 12.5%.

The crux of the method is the acetylation of the fibrous material with acetic anhydride under particularly mild conditions. Preferably, the treating of the lignocellulosic fibrous material with acetic anhydride occurs in step i) so that the treatment occurs at a temperature of about 90 to 140° C. and a pressure of about ±150 mbar below/above standard pressure for a time period of about 1 to 8 hours.

Under these conditions, the acetic anhydride is usually in the liquid aggregate state while the lignocellulosic fibrous material is solid. Alternatively, however, the acetic anhydride can also be used as steam (i.e. in gaseous form) under the appropriate conditions. Further preferably, the method is implemented such that the weight ratio of acetic anhydride to lignocellulosic fibrous material is approximately 50:1 to 1:1, calculated based on the mass of the lignocellulosic fibrous material. Particularly preferentially, the ratio amounts to approximately 35:1 to 5:1 and further preferentially, approximately 25:1 to 8:1. Depending on the reaction conditions, a smaller amount of acetic anhydride can also be sufficient such as a ratio ranging from approximately 1:1 to approximately 8:1 and preferentially about 2.5:1 to 5:1.

It has been shown that partial acetylation is sufficient to impart favorable hydrophobic properties to the fibers. In the context of the present invention, the reaction conditions are thus preferably selected such that the product obtained has an acetyl value in the range of from approximately 22 to 45%, further preferentially in the range of 24 to 38%, and even more preferentially in the range of 28 to 35%. The acetyl value can thereby be influenced by, for example, the reaction time, the amount of acetic anhydride used or the reaction temperature. Additionally or alternatively thereto, the reaction conditions can be regulated such that a degree of substitution DS in the range of from 0.7 to 1.5, preferably 0.8 to 1.35, and further preferentially 0.9 to 1.25, and even more preferentially 0.95 to 1.22 is maintained. As regards the specified upper limits of the acetyl value and the degree of substitution, it has been shown that there is no longer any appreciable change in the absorption of water at higher acetylations. A higher acetylation is coupled with the disadvantages of higher material usage (acetic anhydride) and/or longer reaction times. In contrast, falling short of the cited lower limits no longer achieves the objective's desired extent of improved hydrophobicity properties.

The distillative separation of the acetic acid occurs in step iii) of the above-described method. To that end, method step iii) is preferably performed such that the distillative separation of the acetic acid ensues at reduced pressure (<800 mbar), and in particular at approximately 50 to 60 mbar.

Step iii) can either take place at the same time as the lignocellulosic fibrous material treatment with acetic anhydride in step (i) or at a different time, e.g. after separation of the acetylated fibrous material from the excess acetic anhydride. For a distillative separation simultaneous with the reaction in step (i), one takes advantage of the fact that acetic anhydride under standard pressure has a boiling point of approximately 140° C. whereas acetic acid is already boiling at approximately 120° C. On the other hand, acetic acid and acetic anhydride are liquid at ambient temperature and can thus be easily separated from the solid fibrous material. It can therefore also be appropriate to first separate the solid fibrous material by filtration of said solid fibrous material and then subsequently separate the liquid constituents of the filtrate distillatively.

Separating the acetylated lignocellulosic fibrous material from the excess acetic anhydride occurs in step ii). Since in contrast to the excess acetic anhydride, the lignocellulosic fibrous material is solid, it is appropriately separated via filtration. The filtrate thereby obtained can then be purified further, preferentially first by eliminating the acetic anhydride and/or acetic acid residues still adhering to the fibers under reduced pressure. A pressure in the range of approximately 20 to 80 mbar, and preferentially 50 to 60 mbar, can be specified as a suitable pressure for this treatment. In order to improve the effectiveness of the treatment under reduced pressure, doing so expediently ensues at an increased temperature (compared to 25° C.), preferentially at least 40° C. and particularly preferentially in the range of from 50 to 70° C. Acetic anhydride and acetic acid separated in this manner can be combined with the acetic anhydride separated in method step ii) and supplied to step iii) of the method.

In order to obtain a sufficiently pure enough lignocellulosic fibrous material, however, a comparatively long treatment time is required when treating exclusively at reduced pressure. It is therefore advisable to eliminate residual traces of acetic acid and acetic anhydride via an extraction step. This can be done for example by washing the fibers in water, whereby warm water (i.e. at a temperature of >25° C.) or cold water (i.e. at a temperature of <25° C.) can be used. Washing first with cold water and then with warm water is preferential.

Intensive washing which produces large amounts of wash solution is generally not necessary because no catalyst residues adhere to the fibers such that there is no cleaning problem in this regard.

Alternatively, residual traces of acetic acid and acetic anhydride can also be removed via extraction (e.g. soxhlation) with a non-polar solvent in which the acetylated lignocellulose fibers do not dissolve. Ether solvents, and in particular diethyl ether and methyl Cert-butyl ether, are cited as an example of such a solvent.

In one particularly preferential embodiment of the present invention, step ii) comprises a separating of the lignocellulosic fibrous material acetylated in step i) from the excess acetic anhydride and any existing acetic acid by filtering, the resulting acetylated lignocellulosic fibrous material filtered out is then treated under reduced pressure, in particular at a pressure of about 50 to 60 mbar, and washed with water in order to remove any adhering residues of acetic acid and acetic anhydride.

This sequence of steps results in an acetylated fibrous material which is essentially free of acetic anhydride and/or acetic acid and is thus completely odorless. Meant here by “essentially free” is that the acetylated fibrous material contains a residual content of less than 50 ppm, preferably less than 10 ppm, and particularly preferentially less than 1 ppm of acetic acid and/or acetic anhydride.

The present invention also relates to an acetylated lignocellulosic fibrous material produced by the above-described method. This fibrous material is characterized by a highly hydrophobized surface, which results in improved compatibility with many surface treatments such as for example painting and bonding. At the same time, the fibrous material's significantly lower water absorption makes the materials significantly less susceptible to cracking and deformation when used as a component of composite materials, construction materials or insulation materials. Lastly, the hydrophobization of the fibrous material also counteracts microbiological degradation and at the same time enables the use of biocidal or fungicidal substances to be reduced or dispensed with. The acetylated lignocellulosic fibrous materials produced according to the invention concurrently exhibit no discoloration and, due to the mild reaction conditions in the production process, nor do any odorous and/or toxicologically harmful by-products such as furfurylaldehyde result. Because no catalyst is used in the production of the materials according to the invention, nor are there any problems with long-term stability attributable to catalyst residues still adhering thereto.

In accordance with the above, the inventively produced acetylated lignocellulosic fibrous material preferably has an acetyl value in the range of from approximately 22 to 45%, further preferentially in the range of 24 to 38%, and even more preferentially in the range of 28 to 34%. Additionally or alternatively thereto, the inventively produced acetylated lignocellulosic fibrous material has a degree of substitution DS in the range of from 0.3 to 1.5, preferably 0.35 to 1.35, further preferentially 0.4 to 1.25, and even more preferentially 0.45 to 1.22.

The aforementioned advantages make the inventively produced acetylated lignocellulosic fibrous materials particularly suitable for use as a component of composite materials, particularly in the form of compounds as used in visible and non-visible areas in vehicle construction such as door panels, seating shells and rear shelves, for example, and in horticulture, furniture construction and household goods.

The acetylated lignocellulosic fibrous materials produced according to the invention are equally suitable as a component of construction or insulation materials, particularly in the form of batting and blow-in insulation, insulating mats and nonwovens. The absorption of oil is a further suitable application for the acetylated lignocellulosic fibrous materials.

The following examples illustrate the advantages of the inventive method and its subsequently produced acetylated lignocellulosic fibrous materials in greater detail:

### EXAMPLE 1: ACETYLATION OF HEMP LITTER WITHOUT DISTILLING OFF THE ACETIC ACID ALTHOUGH WITH SUBSEQUENT ACETIC ANHYDRIDE PURIFICATION

85 g of hemp litter (10.5% moisture) is placed in a 1000 ml round bottom flask. 350 g of acetic anhydride (91%) is then added and the mixture refluxed with an oil bath. After 2 h reflux, the mixture is cooled and the litter filtered through a coarse sieve. The resulting acetic acid is distillatively separated (60 mbar, 80° C.) from the acetic anhydride filtrate and the acetic anhydride thereafter distillatively purified so it can be used it for a further acetylation. The hemp litter is freed from the filtrate in a vacuum to dryness and then washed with water to pH neutral. The hemp litter is subsequently oven-dried at 60° C. for two days. A yield of 83.9 g (<1% residual moisture) of the thusly produced acetylated hemp litter was obtained. The acetylated hemp litter exhibits an onset temperature in the TGA measurement of 327.6° C. It had an acetyl value of 27.5% (DS: 0.91). The product has no identifiable discoloration. The color index of the recovered acetic anhydride was 12, the color index of the recovered acetic acid was 19.

Moisture absorption: The moisture absorption was determined with the MA 37-1 infrared moisture analyzer from Sartorius.

The thermal stability was determined with a thermogravimetric analyzer (TGA) from the Netzsch company (TG209F1 Libra, 20K/min).

The acetylated hemp litter took on 2.2% moisture within 24 hours. Hemp litter which was not dried and acetylated as above took on approximately 7% moisture under the same conditions.

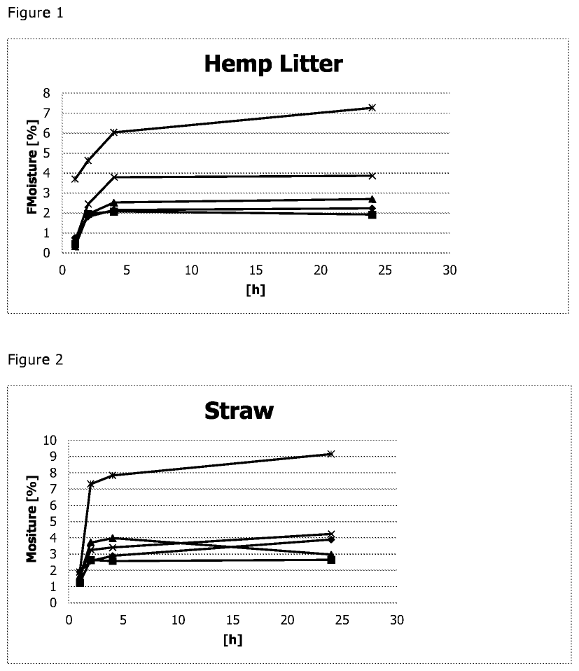

A further acetylated hemp litter product was produced along the same lines as the above description, whereby the reaction time was 8 h. Further acetylated hemp litter products were produced at reaction times of 1, 4 and 8 h, whereby the starting material was in each case dried to a residual moisture content of <1% before the reaction. The properties of the thusly produced hemp litter products are reproduced in Table 1 below. The results of the moisture absorption analyses are depicted in FIG. 1. The X in FIG. 1 denotes the non-acetylated hemp litter.

TABLE 1

| Pre-dried | Acetylation | Acetyl value | | Identification |
|---|---|---|---|---|
| hemp litter | time [h] | [%] | DS | mark |
| no | 8 | 30.75 | 1.06 | ♦ |
| yes | 8 | 31.09 | 1.07 | ▪ |
| yes | 4 | 29.97 | 1.02 | ▴ |
| yes | 1 | 26.12 | 0.86 | X |

### EXAMPLE 2: ACETYLATION OF STRAW

10 g of straw (12.21% moisture) is placed in a 1000 ml round bottom flask. 332 g of acetic anhydride (91%) is then added and the mixture refluxed with an oil bath. After 8 h reflux, the mixture is cooled and the straw filtered through a coarse sieve. The straw is freed from the filtrate in a vacuum to dryness and then washed with water to pH neutral. The straw is subsequently oven-dried overnight at 95° C. A yield of 9.93 g (<1% residual moisture) of the thusly produced acetylated straw was obtained. It had an acetyl value of 33.05% (DS: 1.16). The acetylated straw exhibits an onset temperature in the TGA measurement of 334.4° C.

Various samples of acetylated straw of different acetylation times/degrees were produced (see Table 2). The samples took on 2.5-4% moisture after 24 hours (see FIG. 2). The X in FIG. 2 denotes the non-acetylated straw.

### Acetyl Value According to Acetylation Time:

| Pre-dried | Acetylation | Acetyl value | | Identification |
|---|---|---|---|---|
| straw | time [h] | [%] | DS | mark |
| no | 8 | 33.05 | 1.16 | ♦ |
| yes | 8 | 34.06 | 1.21 | ▪ |
| yes | 4 | 32.34 | 1.13 | ▴ |
| yes | 1 | 27.81 | 0.93 | X |

### EXAMPLE 3: ACETYLATION OF HEMP INSULATION MATERIALS

30 g of hemp insulation material from the Thermo Nature company (10.2% moisture) is placed in a 250 ml round bottom flask. 1500 g of acetic anhydride (91%) is then added and the mixture refluxed with an oil bath. After 8 h reflux, the mixture is cooled overnight and then filtered through a coarse sieve. The hemp insulation material is freed from the filtrate in a vacuum to dryness and then washed with water to pH neutral. The hemp insulation material is subsequently oven-dried overnight at 60° C. A yield of 31.7 g (<1% residual moisture) of the thusly produced acetylated insulation material was obtained. It had an acetyl value of 20.6% (DS: 0.65). The acetylated insulation material exhibits an onset temperature in the TGA measurement of 316.2° C.

1. A method for the acetylation of lignocellulosic fibrous materials which comprises the steps of:
(i) treating the lignocellulosic fibrous material with acetic anhydride in the absence of a catalyst under a pressure of no greater than 0.5 bar above standard pressure (101325 Pa) and a temperature of ≤200° C.;
(ii) separating the acetylated lignocellulosic fibrous material from excess acetic anhydride, and
(iii) distillatively separating the acetic acid generated during acetylation.

2. The method according to claim 1,
wherein the lignocellulosic fibrous material is a natural fiber selected from the group consisting of hemp fibers, flax fibers, jute fibers, rapeseed fibers, miscanthus fibers and palm fibers.

3. The method according to claim 1,
wherein the lignocellulosic fibrous material is pre-dried prior to the step of treating the lignocellulosic fibrous material by applying a vacuum or by heating.

4. The method according to claim 1,
wherein the step of pre-drying of the lignocellulosic fibrous material ensues at a temperature of approximately 80° C. to 95° C. and a pressure of approximately 50 mbar to 100 mbar for a time period of approximately 4 hours to 12 hours.

5. The method according to claim 1,
wherein the step of treating the lignocellulosic fibrous material with acetic anhydride occurs at a temperature of approximately 90° C. to 140° C. and a pressure of approximately ±150 mbar below/above the standard pressure for a time period of approximately 1 hour to 8 hours, wherein the weight ratio of acetic anhydride to lignocellulosic fibrous material is approximately 35:1 to 5:1, and wherein the weight ratio is calculated based on the mass of the lignocellulosic fibrous material.

6. The method according to at least claim 1,
wherein the acetic anhydride is in a gaseous form.

7. The method according to claim 1,
wherein the step of distillatively separating the acetic acid is conducted under a vacuum at approximately 50 mbar to 60 mbar.

8. The method according to claim 1,
further comprising the steps of:
(iv) eliminating any acetic anhydride and acetic acid residues adhered to the acetylated lignocellulosic fibrous material by treating the acetylated lignocellulosic fibrous material filtered out under reduced pressure of approximately 50 mbar to 60 mbar; and
(v) washing the fibrous material obtained in step (iv) with water.

9. The method according to claim 1,
wherein the step of distillatively separating the acetic acid occurs simultaneously with the step of treating the lignocellulosic fibrous material.

10. The method according to claim 1,
the step of distillatively separating the acetic acid occurs after the step of separating the acetylated lignocellulosic fibrous material from the excess acetic anhydride.

11. An acetylated lignocellulosic fibrous material produced pursuant to the method according to claim 1.

12. The acetylated lignocellulosic fibrous material according to claim 11,
wherein the acetylated lignocellulosic fibrous material has an acetyl value in the range of 22% to 45% and a degree of substitution (DS) in the range of 0.3 to 1.5.

13. The acetylated lignocellulosic fibrous material according to claim 11, wherein the acetylated lignocellulosic fibrous material is configured to be used as a component of composite materials, for use in horticulture, furniture construction, household goods and vehicle construction.

14. The acetylated lignocellulosic fibrous material according to claim 11 wherein the acetylated lignocellulosic fibrous material is configured to be used as a component of building materials, insulating materials, batting and blow-in insulation materials, insulating mats, nonwovens, or as an absorbent for oil.
